(19) United States
(12) Patent Application Publication
(10) Pub. No.: US 2014/0176515 A1
(43) Pub. Date: Jun. 26, 2014

(54) DISPLAY DEVICE AND METHOD FOR PROCESSING FRAME THEREOF

(71) Applicant: CHUNGHWA PICTURE TUBES, LTD., Taoyuan (TW)

(72) Inventors: Cheng-Hao Ko, Taoyuan County (TW); Ching-Huei Ku, New Taipei City (TW)

(73) Assignee: CHUNGHWA PICTURE TUBES, LTD., Taoyuan (TW)

(21) Appl. No.: 13/786,479

(22) Filed: Mar. 6, 2013

(30) Foreign Application Priority Data
Dec. 22, 2012 (TW) 101149287

(51) Int. Cl. G09G 5/00

(52) U.S. Cl. CPC G09G 5/003
USPC 345/204

(57) ABSTRACT

A display device and a method for processing frame are provided. The display device includes a display panel, a source driver, a gate driver, a timing controller and a frame processing module. The frame processing module is coupled to the timing controller, configured for receiving a first frame data, a converting command signal, a data enable signal and a synchronization signal and providing a display frame data to the timing controller. The frame processing module determines a type of the display frame data according to the converting command signal. The frame processing module determines a timing point of adjusting the type of the display frame data according to timings of the converting command signal, the data enable signal and the synchronization signal.

### CROSS-REFERENCE TO RELATED APPLICATION

This application claims the priority benefit of Taiwan application serial no. 101149287, filed on Dec. 22, 2012. The entirety of the above-mentioned patent application is hereby incorporated by reference herein and made a part of this specification.

### TECHNICAL FIELD

The invention relates to a display device and a method for processing a frame thereof, and also relates to a 2D/3D switchable image display device and a method for processing a frame.

BACKGROUND

The three-dimensional (3D) display technique is the mainstream in the current digital display trend. Irrespective of the type of application of the 3D display technique in the entertainment field, the field of medical research or other fields, the users demand an improved simulated sense of presence in a virtual environment. In terms of entertainment, when the users are watching 3D movies or playing 3D videogames, the 3D display technique creates the visual effect of an object shooting toward the users and flying out of the screen, so as to give the users the illusion of being present. As such, the 3D display technique indeed leads to a new trend and development targets in the movie and gaming industry.

Generally speaking, because of the users' preferences, a majority of display devices displays a two-dimensional image (namely a flat image) and not a 3D image. Accordingly, when designing a display device for displaying a 3D image, the conversion between 2D and 3D images has to be considered. If the timing of conversion between 2D and 3D is not properly considered, abnormal phenomenon, for example line-decimated phenomenon, may occur in the display image.

### SUMMARY

The disclosure is directed to a display device and a method for processing a frame thereof, wherein the frame conversion time point is adjusted according to the corresponding relationship of the enable timings between the converting command and the data enable signal.

An exemplary embodiment of the disclosure provides a display device that includes a display panel, a source driver, a gate driver, a timing controller and a frame processing module. The source driver is coupled to the display panel to drive the display panel. The gate driver is coupled to the display panel to drive the display panel. The timing controller is coupled to the source driver and the gate driver for receiving a display frame data in order to drive the source driver and the gate driver. The frame processing module, coupled to the timing controller, receives a first frame data, a converting command signal, a data enable signal and a synchronization signal and provides the display frame data. The frame process module determines the types of the display frame data according to the converting command signal and the time point for adjusting the type of the display frame data according to the timings of the converting command signal, the data enable signal and the synchronization signal.

According to an exemplary embodiment of the disclosure, the aforementioned processing module includes a buffer, a converter unit, a first switch, a detection unit and a second switch. The buffer receives and stores the first frame data. The converter unit is used to convert the first frame data to a second frame data, wherein the type of the second frame data is different from the type of the first frame data. The first switch is coupled between the buffer and the converter unit, and is turned on in response to the converting command signal. The detection unit receives the data enable signal, the converting command signal and the synchronization signal, and outputs a switching signal. The detection unit determines the voltage level of the switching signal according to the timings of the converting command signal, the data enable signal and the synchronization signal. The second switch is coupled to the detection unit and the timing controller. The second switch couples the timing controller to the buffer or the converting unit in response to the switching signal.

According to an exemplary embodiment of the disclosure, the abovementioned first frame data is a two dimensional (2D) frame data and the second frame data is a three dimensional (3D) frame data.

According to an exemplary embodiment of the disclosure, when the converting command signal is enabled at the enable period of the data enable signal, the detection unit, at the enable period of the data enable signal, disables the switching signal for the controller to couple to the buffer. Moreover, the detection unit, at the next enable period of the synchronization signal, enables the switching signal for the timing controller to couple to the converter.

According to an exemplary embodiment of the disclosure, when the converting command signal is enabled at the disable period of the data enable signal, the detection unit enables the switching signal for the timing controller to couple to the converter.

According to an exemplary embodiment of the disclosure, the abovementioned switching signal is preset as disabled.

According to an exemplary embodiment of the disclosure, when the converting command signal is enabled at the enable period of the data enable signal, the frame processing module, at the enable period of the data enable signal, outputs the received first frame data as the display frame data. Moreover, the frame processing module adjusts the type of the display frame data at the next enable period of the synchronization signal.

According to an exemplary embodiment of the disclosure, when the converting command signal is enabled at the disable period of the data enable signal, the frame processing module adjusts the type of the display frame data.

According to an exemplary embodiment of the disclosure, prior to enabling the converting command signal, the frame processing module sets the type of the display frame data as a 2D frame data. Subsequent to enabling the converting command signal, the frame processing module sets the type of the display frame data as a 3D frame data.

An exemplary embodiment of the disclosure provides a frame processing method for a display device. The method is applicable in a frame processing module in the display device and includes at least the following process steps. A first frame data, a converting command signal, a data enable signal and a synchronization signal are received, and a display frame data is accordingly provided to a timing controller. The type of the display frame data is determined according to the converting command signal. The time point for adjusting the type of the display frame data is determined according to timings of the converting command signal, the data enable signal and the synchronization signal.

According to an exemplary embodiment of the disclosure, the step of determining the time point for adjusting the type of the display frame data according to timings of the converting command signal, the data enable signal and the synchronization signal includes : when the converting command signal is enabled at the enable period of the data enable signal, outputting the received first frame data instantly at the enable period of the data enable signal as the display frame data; and adjusting the type of the display frame data at the next enable period of the synchronization signal.

According to an exemplary embodiment of the disclosure, the step of determining the time point for adjusting the type of the display frame data according to timings of the converting command signal, the data enable signal and the synchronization signal includes : adjusting the type of the display frame data when the converting command signal enables at the disable period of the data enable signal.

According to an exemplary embodiment of the disclosure, the step of determining the type of display frame data according to the converting command signal includes : setting the type of the display frame data as a 2D frame data prior to enabling the converting command signal; and setting the type of the display frame data as a 3D frame data subsequent to enabling the converting command signal.

Based on the above disclosure, in the display device and the frame processing method thereof of the exemplary embodiments of the invention, the frame processing module determines the time point for adjusting the type of the display frame data according to the timings of the converting command signal, the data enable signal and the synchronization signal the converting command. Accordingly, the display frame is prevented from any occurrence of abnormal phenomenon.

The invention and certain merits provided by the invention can be better understood by way of the following exemplary embodiments and the accompanying drawings, which are not to be construed as limiting the scope of the invention.

### BRIEF DESCRIPTION OF THE DRAWINGS

FIG. 1 is a schematic diagram of a display device according to an exemplary embodiment of the disclosure.

FIG. 2A is a waveform diagram according to an exemplary embodiment of the disclosure.

FIG. 2B is a waveform diagram according to another exemplary embodiment of the disclosure.

FIG. 3 is a schematic diagram of a function block diagram of a frame processing module according to the exemplary embodiment of the disclosure in FIG. 1.

FIG. 4A is a schematic diagram of the frame processing module in FIG. 3 when the converting command is disabled.

FIG. 4B is a schematic diagram of the frame processing module in FIG. 3 when the converting command is enabled.

FIG. 4C is a schematic diagram of the frame processing module in FIG. 3 when the conversion command is enabled.

FIG. 5 is a flow chart of steps in an exemplary method for frame processing according to an exemplary embodiment of the disclosure.

### DETAILED DESCRIPTION OF DISCLOSED EMBODIMENTS

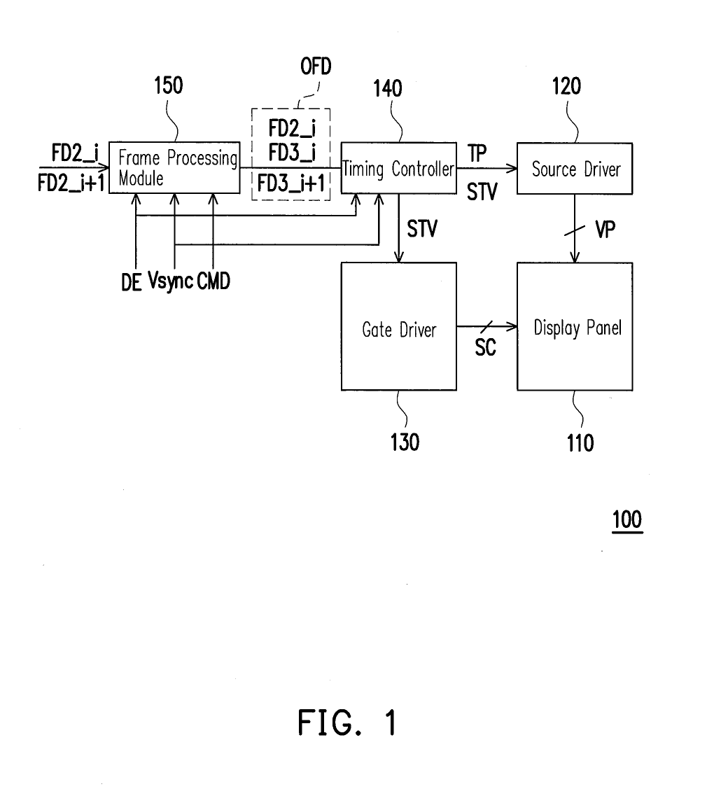

FIG. 1 is a schematic diagram of a display device according to an exemplary embodiment of the disclosure. In this exemplary embodiment, the display device 100 includes a display panel 110, a source driver 120, a gate driver 130, a timing controller 140 and a frame processing module 150. The display panel 110 is coupled to and controlled by the source driver 120 and the gate driver 130 for driving to display. The timing controller 140 is coupled to the source driver 120, the gate driver 130 and the frame processing module 150, and the source driver 120 and the gate driver 130 are controlled according to the frame provided by the frame processing module 150.

In an exemplary embodiment, after receiving a two dimensional (2D) frame data FD2_i (corresponding to a first frame data), the frame processing module 150 determines whether the type of the display frame data corresponds to a 2D frame or to a 3D (three dimensional) frame based on the converting command signal CMD. Further, the time point for adjusting the type of display frame data OFD is determined according to the timings of the data enable signal DE, the synchronization signal Vsync and the converting command signal CMD. Moreover, the timing controller 140 receives the display frame data OFD provided by the frame processing module 150 according to the data enable signal DE and the synchronization signal Vsync.

The source driver 120 and the gate driver 130 perform operations based on the control signal generated by the timing controller 140 (exemplified by the frame-starting signal STV and the data latch signal TP herein), wherein the frame-starting signal STV is a starting signal of each frame. When the gate driver 130 receives the frame starting signal STV, the gate driver 130 outputs the scan signals sequentially to the driver display panel 110 to drive all the pixels in the display panel row-by-row. Moreover, the source driver 120 receives the data provided by the timing controller 140 according to the frame-starting signal STV, and in reference to the data latch signal TP, outputs the pixel voltage VP to the display panel 110 for the display panel 110 to generate a corresponding image frame.

Generally speaking, the data enable signal DE is being alternately enabled and disabled; in other words, the data enable signal DE includes a plurality of alternating enable periods and disable periods. When the data enable signal DE is at the enable periods, the timing controller 140, in response to the data enable signal DE, receives the display frame data OFD generated by the frame processing module 150. During the disable periods, the timing controller 140 will not receive the data enable signal generated by the frame processing module 150. The durations of the enable periods and the disable periods are adjusted according to the design demands. The synchronization signal Vsync signifies the starting time point of a frame and the synchronization signal is enabled during the periods that the data enable signal DE is converted to being disabled.

The converting command signal CMD control that the pixel processing module 150 converts a 2D frame data FD2_i to a 3D frame data FD3_i. Namely, the pixel process module 150, in response to the enabling of the converting command signal CMD, converts the 2D frame data FD2_i from 2D to 3D for generating a corresponding frame data FD3_i (namely, a 3D version of the frame data FD2_i). In this exemplary embodiment, the frame processing module 150 receives and stores the frame data FD2_i, the subsequent frame processing is thereby facilitated. Alternatively speaking, before the converting command signal CMD is enabled, the frame processing module 150 sets the type of the display frame data OFD as a 2D frame data (that is, the frame data FD2_i is outputted directly). Subsequent to the enabling of the converting command signal CMD, the frame processing module 150 sets the type of the display frame data OFD as a 3D frame data (that is the frame data FD3_i).

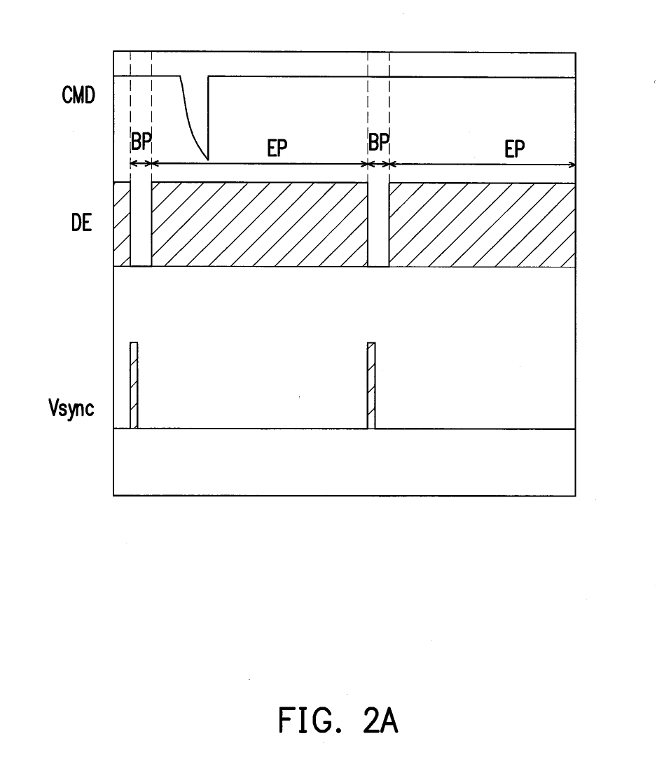

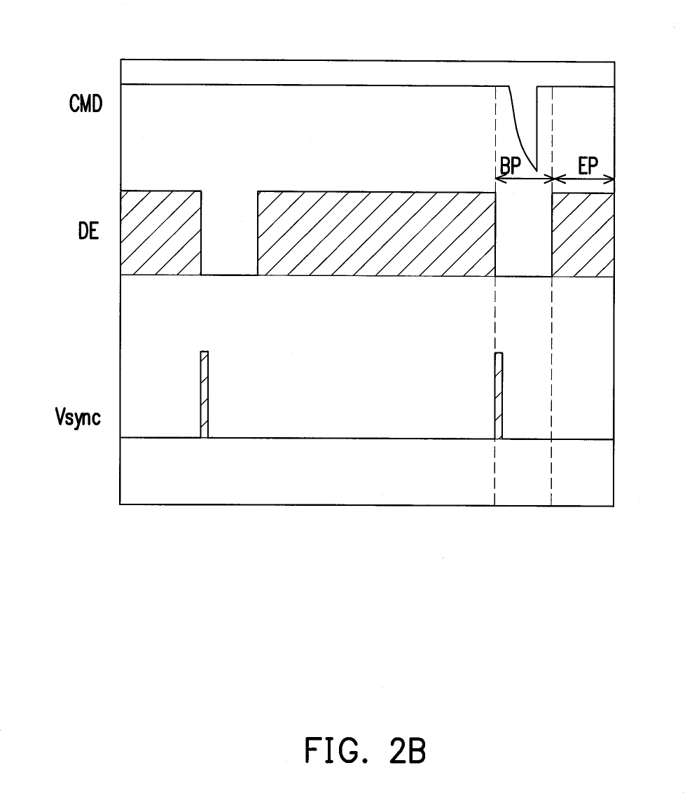

FIG. 2A is a waveform diagram according to an exemplary embodiment of the disclosure. In this exemplary embodiment, the synchronization signal Vsync (a high voltage level is exemplified herein) is enabled at the starting point of the disable period BP of the data enable signal DE (the data enable signal DE is at a low voltage level period), and the converting command signal CMD is enabled (a low voltage level is exemplified herein) within the enable period EP of the data enable signal DE. At present, the frame processing module 150, which is controlled by the converting command signal, converts the 2D frame data FD2_i to a 3D frame data.

Within the enable period EP of the data enable signal DE, the timing controller 140 controls the source driver 120 to output the pixel voltage VP. If the frame processing module 150, at this moment, directly converts the display frame data of the 2D frame (which is the frame data FD2_i) to a display frame data OFD of a 3D frame (which is a frame data FD3_i) and outputs to the timing controller 140, the operations of the timing controller 140 and the source driver 120 may be affected because frame conversion is unable to complete promptly. Consequently, the display frame of the display panel 110 may resulted with the line-decimated problem.

FIG. 2B is a waveform diagram according to another exemplary embodiment of the disclosure. Referring to FIG. 2B, in this exemplary embodiment, the converting command signal CMD is enabled (a low voltage level is exemplified herein) during the disable period BP of the data enable signal DE. Within the disable period BP of the data enable signal DE, the timing controller 140 does not control the source driver 120 to output the pixel voltage VP; namely, the source driver 120 will not output the pixel voltage VP. If the frame processing module 150, at this moment, directly converts the display frame data of the 2D frame (namely, the frame data FD2_i) to a display frame data OFD of a 3D frame (namely, a frame data FD3_i) and outputs to the timing controller 140, the operations of the timing controller and the source driver 120 are not affected. Hence, the display frame of the display panel 110 is obviated of the line-decimated problem.

Accordingly, in order to circumvent a display problem resulted from the enable time point of the converting command signal CMD falls within the enable period EP of the signal enable signal DE, the frame processing module 150 detects whether the enable time point of the converting command signal CMD falls within the enable period EP of the signal enable signal DE after the enabling of the converting command signal CMD. If the enable time point of the converting command signal CMD falls within the enable period EP of the signal enable signal DE, the frame processing module 150 will not output the converted frame data FD2_i (for instance, frame data FD3_i) as the display frame data OFD within the enable period EP of the data enable signal DE. For instance, as shown in FIG. 1, the frame processing module 150 uses the currently outputted frame data FD2_i as the display frame data OFD. Thereafter, in the next data enable period EP of the data enable signal DE, the converted frame data FD2_i+1 (for example, frame data FD3_i+1) is outputted as the display frame data OFD.

When frame processing module 150 determines that the enable time point of the converting command signal CMD falls within the disable period BP of the signal enable signal DE, the frame processing module 150 directly outputs the converted frame data FD2_i (for instance, frame data FD3_i) as the display frame data OFD.

In an exemplary embodiment of the disclosure, the frame process module 150 may include an OR gate, and the voltage level detection function is realized through the OR gate. The input ends of the OR gate receives the data enable signal DE and the converting command signal CMD, respectively. When the converting command signal CMD is enabled (for example, the low voltage level as shown in FIG. 2B), and the data enable signal DE is disabled (for example, the low voltage level as shown in FIG. 2B), the OR gate of the frame process module 150 outputs a low voltage level, indicating that the frame process module 150 may directly output the converted frame data FD2_i (for example, frame data FD3_i) as the display frame data OFD.

Alternatively, when the converting command signal CMD is enabled (for example, the low voltage level as shown in FIG. 2A) and the data enable signal is enabled (example, the low voltage level as shown in FIG. 2A), the OR gate of the frame process module 150 outputs the high voltage level, which indicates the frame process module 150 will output the converted frame data FD2_i+1 (for example, frame data FD3_i+1) as the display frame data OFD in the next enable period EP of the data enable signal DE. It should be noted that the above exemplary embodiments are not to be construed as limiting the scope of the disclosure in any manner.

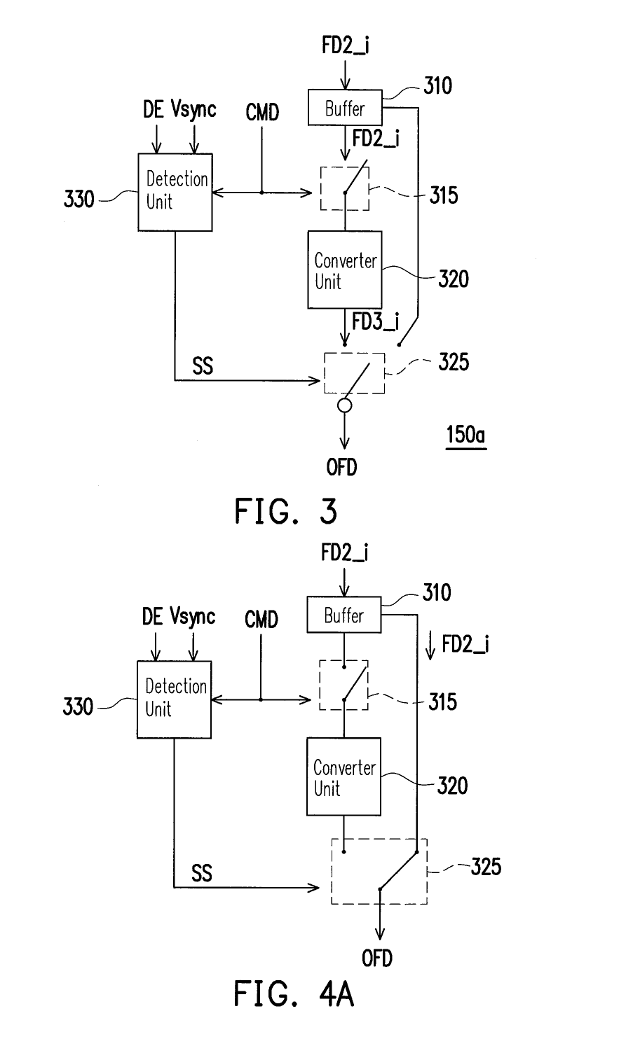

FIG. 3 is a schematic diagram of a function block diagram of a frame processing module according to the exemplary embodiment of the disclosure in FIG. 1. Referring to both FIGS. 1 and 3, in this exemplary embodiment, the frame processing module 150a includes a buffer 310, a first switch 315, a converter unit 320, a second switch 325, and a detection unit 330. The buffer 310 receives and stores the frame data FD2_i. The converter unit 320 is used for converting the frame data FD2_i to a frame data FD3i, wherein the type of the frame data FD2_i is different from the type of the frame data FD3_i. The first switch 315 is coupled between the buffer 310 and the converter unit 320, and is turned on in response to the converting command signal CMD. The detection unit 330 is coupled to the data enable signal DE and the synchronization signal Vsync. The detection unit 330 receives the data enable signal DE, the converting command signal CMD and the synchronization signal Vsync, and outputs the switching signal SS. The detection unit 330 determines the voltage level of the switching signal SS according to the timings of the converting command signal CMD, the data enable signal DE and the synchronization signal Vsync. The second switch 325 is coupled to the detection unit 330 and the timing controller 140, and in response to the switching signal SS, the second switch 325 couples the timing controller 140 to the buffer 310 or the converter unit 320.

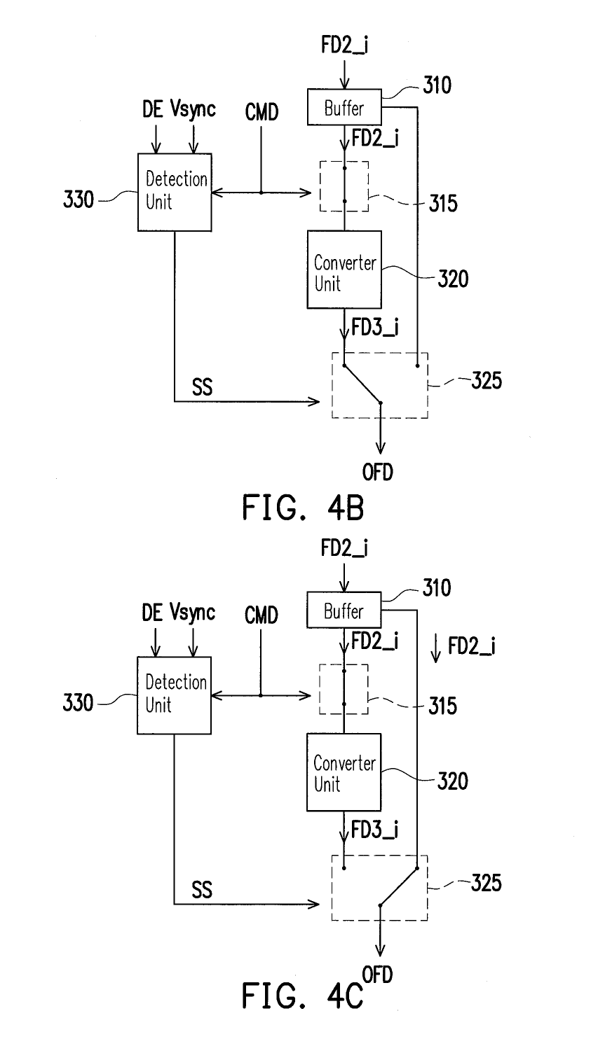

FIG. 4A is a schematic diagram of the frame processing module in FIG. 3 when the converting command is disabled. Referring to FIGS. 3 and 4A, in this exemplary embodiment, prior to converting command signal CMD is enabled, the converting command signal CMD signifies that a conversion of the 2D frame data FD2 i to a 3D frame data FD3_i by the frame processing module 150 is not required. Accordingly, the first switch 315 is turned off according to the converting command signal CMD to avert a transmission of the frame data FD2_i to the converter unit 320. Concurrently, the detection unit 330 presets the switching signal SS as disabled, and when the converting command signal CMD is determined as disabled, the second switch 325 is controlled via the disable of the switching signal SS to couple the buffer 310 to the timing controller 140. As a result, the frame data FD2_i is directly transmitted from the buffer 310 to the timing controller 140. Namely, the display frame data OFD is the frame data FD2_i.

FIG. 4B is a schematic diagram of the frame processing module in FIG. 3 when the converting command is enabled. Referring to FIGS. 3 and 4B, in this exemplary embodiment, it is assumed that the converting command signal CMD is enabled within the disable period of the data enable signal DE (as shown in FIG. 2B). The enabled converting command signal CMD indicates that the conversion of the 2D frame data FD2_i to a 3D frame data FD3_i by the frame processing module 150 is required. The first switch 315 is thereby turned on according to the converting command signal CMD for the frame data FD2_i to be transmitted to the converter unit 320. Thereafter, the converter unit 320 converts the frame data FD2_i to generate the frame data FD3_i.

Concurrently, the detection unit 330 determines that the enable time point of the converting command signal CMD falls within the disable period of the data enable signal DE. The detection unit 330 then enables the switching signal SS to control the second switch 325 to couple the converter unit 320 to the timing controller 140. Consequently, the frame data FD3_i can be directly outputted to the timing controller 140 from the converter unit 320.

FIG. 4C is a schematic diagram of the frame processing module in FIG. 3 when the converting command is enabled. Referring to FIGS. 3, 4B and 4C, in this exemplary embodiment, it is assumed that the converting command signal CMD is enabled at the enable period of the data enable signal DE (as in the situation depicted in FIG. 2A). The enabled converting command signal CMD indicates that the frame processing module 150 is required to convert the frame data FD2_i to a 3D frame data FD3_i. Accordingly, the first switch 315 is turned on according to the converting command signal CMD for the frame data FD2_i to be transmitted to the converting unit 320 to generate the frame data FD3_i.

Meanwhile, the detection unit 330 can determine that the enable time point of the converting command signal CMD falls within the enable period of the data enable signal DE. Therefore, the switching signal SS remains disabled by the detection unit 330 in order to control the second switch 325 to couple the buffer 310 to the timing controller 140. Hence, the frame data FD3_i is circumvented from being directly outputted to the timing controller 140 as the display frame data OFD, and any occurrence of abnormal phenomenon (for instance, the line-decimated phenomenon) in the display frame can be prevented.

Thereafter, the detection unit 330 enables the switching signal SS, in the next enable period of the synchronization signal Vsync, for the timing controller 140 to couple to the switching unit 320. Accordingly, the frame processing module 150 can output the converted frame data FD2_i (for example, frame data FD3_i) as the display frame date.

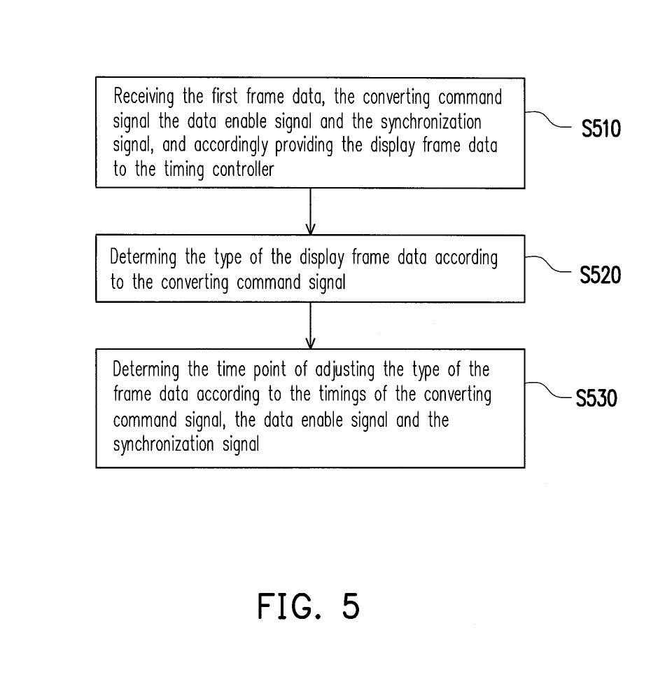

FIG. 5 is a flow chart of steps in an exemplary frame processing method according to an exemplary embodiment of the disclosure. Referring to FIG. 5, the method provided by this exemplary embodiment is suitable for the frame processing module 150 as depicted in FIG. 1. In step S510, the frame processing module 150 receives the frame data FD2_i, the converting command signal CMD, the data enable signal DE and the synchronization signal Vsync, and accordingly provides the display frame data OFD to the timing controller 140. Then, in step S520, the frame processing module 150 determines the type of the display frame data OFD according to the converting command signal CMD. Thereafter, in step S530, the frame processing module 150, determines the time point for adjusting the type of the frame data OFD according to the timings of the converting command signal CMD, the data enable signal DE and the synchronization signal Vsync. The details of each of the above process steps may refer to exemplary embodiments of FIGS. 1, 2A, 2B, 3 4A to 4C, and are omitted herebelow.

According to the above disclosure, the exemplary embodiments of the invention provide a display device and a processing module that can determine whether the converting command is enabled at the enable period of the data enable signal and determine the time point for adjusting the type of the output display frame data. Accordingly, the display frame of the display panel 110 is obviated from any occurrence of abnormal phenomenon, such as the line-decimated phenomenon.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display device comprising:
a display panel;
a source driver, coupled to the display panel for driving the display panel;
a gate driver, coupled to the display panel for driving the display panel;
a timing controller, coupled to the source driver and the gate driver, and receiving a display frame data to drive the source driver and the gate driver, and
a frame process module, coupled to the timing controller, receiving a first frame data, a converting command signal, a data enable signal and a synchronization signal, and providing the display frame data, and the frame process module determining a type of the display frame data according to the converting command signal, and determining a time point for adjusting the type of the display frame data according to timings of the converting command signal, the data enable signal and the synchronization signal.

2. The display device of claim 1, wherein the frame processing module comprises:
a buffer, receiving and storing the first frame data;
a converter unit, converting the first frame data to a second frame data, wherein a type of the first frame data is different from a type of the second frame data;
a first switch, coupled between the buffer and the converter unit, and turned on in response to the converting command signal;
a detection unit, receiving the data enable signal, the converting command signal and the synchronization signal, and outputting a switching signal, and the detection unit determining a voltage level of the switching signal according to the timings of the converting command signal, the data enable signal and the synchronization signal; and
a second switch, coupled to the detection unit and the timing controller, and coupled the timing controller to the buffer or the converter unit in response to the switching signal.

3. The display device of claim 2, wherein the first frame data is a two dimensional (2D) frame data, and the second frame data is a three dimensional (3D) frame data.

4. The display device of claim 2, wherein when the converting command signal is enabled at an enable period of the data enable signal, the detection unit disables the switching signal at the enable period of the data enable signal for the timing controller to couple to the buffer and enables the switching signal at a next enable period of the synchronization signal for the timing controller to couple to the converter unit.

5. The display device of claim 2, wherein when the converting command signal is enabled at a disable period of the data enable signal, the detection unit enables the switching signal for the timing controller to couple to the converter unit.

6. The display device of claim 2, wherein the switching signal is preset as disabled.

7. The display device of claim 1, wherein when the switching signal is enabled at an enable period of the data enable signal, the frame processing module outputs the received first frame data as the display frame data at the enable period of the data enable signal and adjusts a type of the frame data at a next enable period of the synchronization period.

8. The display device of claim 1, wherein when the converting command signal is enabled at a disable period of the data enable signal, and the frame processing module adjusts the type of the display frame data.

9. The display device of claim 1, wherein before the converting command signal is enabled, the frame processing module sets the type of the display frame data as a 2D frame data, and after the converting command signal is enabled, the frame processing module sets the type of the display frame data as a 3D frame data.

10. A display device frame processing method, applicable in a frame processing module of a display device, the frame processing method comprising following steps:
receiving a first frame data, a converting command signal, a data enable signal and a synchronization signal, and accordingly providing a display frame data to a timing controller;
determining a type of the display frame data according to the converting command signal; and
determining a time point for adjusting the type of the display frame data according to timings of the converting command signal, the data enable signal and the synchronization signal.

11. The frame processing method of claim 10, wherein the step of determining the time point for adjusting the type of the display frame data according to the timings of the converting command signal, the data enable signal and the synchronization signal further comprises:
when the converting command signal is enabled at an enable period of the data enable signal, outputting the received first frame data at the enable period of the data enable signal as the display frame data; and
adjusting the type of the display frame data at a next enable period of the synchronization signal.

12. The frame processing method of claim 10, wherein the step of determining the time point for adjusting the type of the display frame data according to the timings of the converting command signal, the data enable signal and the synchronization signal further comprises :
adjusting the type of the display frame data when the converting command signal is enabled at a disable period of the data enable signal.

13. The frame processing method of claim 10, wherein the step of determining the type of display frame data according to the converting command signal comprises:
setting the type of the display frame data as a 2D frame data before the converting command signal is enabled; and
setting the type of the display frame data as a 3D frame data after the converting command signal is enabled.
